(19) United States
(12) Patent Application Publication
(10) Pub. No.: US 2009/0116605 A1
(43) Pub. Date: May 7, 2009

(54) Nuclear reactor rod control mechanism control system

(75) Inventors: Marc Pouillot, Sassenage (FR); Denis Royanez, Eybens (FR); Paul Olmos, Voiron (FR); Philippe Mandier, Grenoble (FR)

Correspondence Address: OLIFF & BERRIDGE, PLC, P.O. BOX 320850, ALEXANDRIA, VA, 22320-4850, US

(73) Assignee: DATA SYSTEMS & SOLUTIONS, MEYLAN (FR)

(21) Appl. No.: 11/987,889

(22) Filed: Dec. 5, 2007

Related U.S. Application Data
(60) Provisional application No. 60/899,620, filed on Feb. 6, 2007.

(30) Foreign Application Priority Data
Dec. 21, 2006 (FR) 06-11183

(51) Int. Cl. G21C 7/36

(52) U.S. Cl. 376/215

(57) ABSTRACT

The control system comprises an independent removable power module for each coil of a rod control mechanism equipped with three operating coils supplied from a three-phase current source. The power module is connected in series with the corresponding coil and comprises a rectifier circuit with three thyristors controlled in phase angle by a corresponding regulation circuit according to setpoint current values associated with the coil. A monitoring circuit connected to a display interface displays the current flowing in the coil associated with the power module. In the event of a fault, the module and coil involved are easily detected and replaced without requiring shutdown of the whole of the reactor.

### BACKGROUND OF THE INVENTION

The invention relates to a rod control mechanism control system for a nuclear reactor, each mechanism comprising three operating coils supplied from a three-phase current source.

### STATE OF THE ART

In nuclear reactors, control rods designed to be inserted in or withdrawn from is the reactor core, in particular to control the power of the core, are grouped in control rod clusters. Each control rod cluster is connected to a drive rod the movements of which are controlled by a control mechanism. In the pressurized water reactors (PWR) currently operating in the USA as well as in the 900 MW, 1300 MW and 1450 MW pressurized water reactors currently used in France, movement of the drive rods connected to the shutdown and regulation rod clusters is performed discontinuously by means of latch arm mechanisms called grippers. Control is generally performed in sub-groups of 4 rod clusters.

Control of these mechanisms is performed by exciting electromagnet coils in a predetermined order, which coils actuate grippers and a lift assembly. As illustrated in FIG. 1, in the normal position of the mechanism, i.e. with the control rod cluster held stationary, each mechanism 1 comprises three operating coils 2:

A movable gripper coil 2_{GM} which secures drive rod 3 of the rod cluster assembly to a rod travel assembly.

A lift coil 2_{BM} which actuates the rod travel assembly, thus moving the drive rod of the rod cluster one mechanical step if the movable gripper (GM) is engaged.

A stationary gripper coil 2_{GF} which holds the rod of the rod cluster in steady-state operating conditions and during movement of the rod travel assembly without any rod cluster movement.

In the normal position of the mechanism illustrated in FIG. 1, only the stationary gripper coil is excited. If an incident is detected, the-three-phase power supply source of all the mechanisms is cut by reactor trip breakers. All the coils 2 are then de-energized and the mechanisms instantaneously deactivated, causing the control rod clusters to drop and shutdown of the reactor. To move drive rod 3, all the coils are energized according to a predetermined cycle for each movement step.

Each coil can be controlled with 3 current levels:

C0: zero current to de-energize the coil,

C1: reduced current to keep the coil energized, for example 4.7 A for the 2_{GF} and 2_{GM} coils and 16 A for the 2_{BM} coil,

C2 : full current to energize the coil, for example 8 A for the 2_{GF} and 2_{GM} coils and 40 A for the 2_{BM} coil. This level cannot however be maintained indefinitely, otherwise the coil would be thermally damaged.

FIGS. 2a to 2c illustrate an example of current value I versus time t for a lift cycle, respectively for the stationary gripper coil 2_{GF} (FIG. 2a), for the movable gripper coil 2_{GM} (FIG. 2b) and for the lift coil 2_{BM} (FIG. 2c). Likewise, FIGS. 3a to 3c illustrate an example of current value I versus time t for an insertion cycle, respectively in coils 2_{GF} (FIG. 3a), 2_{GM} (FIG. 3b) and 2_{BM} (FIG. 3c).

In present-day power plants, the control rod clusters are arranged in groups, each group comprising one or two sub-groups, and the control rod clusters are normally actuated in sub-groups. A sub-group comprises 4 control rod clusters arranged symmetrically around the center of the core. Exceptionally, if the core comprises a central control rod cluster, the latter constitutes a sub-group by itself.

A function is assigned to each group of control rod clusters. Thus the shutdown control rod clusters operated in manual mode only, the temperature regulation control rod clusters performing high-speed regulation of the mean temperature of the reactor primary circuit, and the power regulation control rod clusters enabling day-to-day variation of the power produced, can be conventionally distinguished, the latter two types of control rod clusters being normally operated in automatic mode. The number of control rod clusters and consequently the number of mechanisms to be controlled is large, typically 61 in a French 900 MW nuclear reactor, which makes the control system complex.

Conventionally, as represented in FIG. 4, a rod control system 4 (conventionally called RCS) is supplied by a three-phase voltage source (three phases plus neutral, with 260 Vrms between phases), via reactor trip breakers 5 receiving a rod cluster drop (emergency shutdown) command signal S1 causing opening of the reactor trip breakers when a fault is detected. Control system 4 controls the currents applied to the three coils of the different rod control mechanisms separately, in particular according to manual control signals S2 from a control room, automatic control signals S3 supplied by various current and/or temperature measurement sensors (not represented), and enable signals S4 from a reactor protection system (not represented), which also supplies signal S1.

Mechanism control system 4 comprises a driver circuit 6 in particular receiving signals S2, S3 and S4 and supplying lift and/or insert and/or stationary hold orders S5 for each sub-group to a sequence generator 7.

Sequence generator 7 then supplies control signals S6 to a converter circuit 8. The latter, together with the three-phase power source, reactor trip breakers 5 and a distribution cabinet 9 arranged line-side from the converter circuit, constitutes the power circuit of the rod cluster control channel. Signals S6 control converter circuit 8 so that the latter supplies the three coils 2 of each mechanism, during suitable time intervals, with the currents corresponding to a lift cycle, an insertion cycle or a hold cycle according to orders S5.

Alignment signals S7, enabling movement of one or more lift coils 2_{BM} to be individually disabled, can be supplied to converter circuit 8 to correct possible misalignments, which would be liable to disturb satisfactory operation of the reactor. Interruption of the movement on a fault or a transient malfunctioning of a mechanism may for example in fact interrupt the movement of one or more rod clusters of a sub-group, which are then no longer aligned height-wise.

Mechanism control circuit 4 is not as such classified “Important For. Safety” (nuclear). Should a dangerous deviation from operating conditions occur, a reactor protection system commands opening of reactor trip breakers 5 by means of rod cluster drop command signal S1 (scram), which cuts the control power of the mechanisms. The rod clusters then drop into the core and the reactor is shut down.

Mechanism control circuit 4 is on the other hand important for reactor availability. Fortuitous shutdown of the reactor in fact gives rise to a very expensive loss of production, and accidental dropping of a single control rod cluster leads to detection of a potentially dangerous rapid flux variation by the protection system, which consequently causes immediate shutdown of the whole reactor.

FIG. 5 illustrates in greater detail a mechanism control system conventionally used for control of a sub-group of 4 control rod clusters in a present-generation 1300 MW or 1450 MW pressurized water reactor. In such a reactor, converter circuit 8 comprises, for each sub-group, a converter 10_{GF} for the 4 stationary gripper coils connected in parallel, a converter 10_{GM} for the 4 movable gripper coils connected in parallel, and a converter 10_{BM} for the 4 lift coils connected in parallel. Each converter 10 is formed by a rectifier with three phase angle controlled thyristors performing parallel command of the four coils of the same type (2_{GF}, 2_{GM} or 2_{BM}) of the four rod clusters of the same sub-group. The control signals of the different thyristors, applied to their gates, are constituted by signals S6 supplied by sequence generator 7.

In FIG. 5, each lift coil 2_{BM} is connected in series with a corresponding alignment thyristor 11. These alignment thyristors, which are normally on, are controlled by alignment signals S7 so as to selectively interrupt the current flow in one or more lift coils, and consequently disable movement of the corresponding control rod clusters.

In such a control system, the current flowing through each coil 2 is measured and a processing circuit (not represented) determines at each moment, the largest (Imax) and smallest (Imin) of the four measured values for each type of coil. Converter 10 associated with the 4 coils of the same type regulates the current value Imax to prevent the coils from being damaged by a too high current. At the same time, current value Imin is monitored by a control circuit (not represented) by means of reference templates or patterns, to guarantee that the rod clusters are properly held and that the cycles are performed correctly. In the event of a fault occurring, this control circuit supplies suitable alarms and if necessary stops the movements and performs simultaneous command of the two types of gripper.

A mechanism control system used for control of 3 sub-groups of 4 rod clusters (i.e. 12 coils of each type) in a present-generation 900 MW pressurized water reactor is illustrated in greater detail in FIG. 6. In such a system, as in the one described in U.S. Pat. No. 3,588,518, the number of converters 10 formed by phase angle controlled rectifiers is minimized, taking account of the fact that control of the 3 sub-groups involved is never performed at the same time.

Thus, in FIG. 6, a single converter 10_{BM}, formed by three thyristors phase angle controlled by signals S6, is associated with the 12 lift coils 2_{BM} of the 3 sub-groups. As in FIG. 5, each lift coil 2_{BM} is connected in series with a corresponding alignment thyristor 11. In the same way, a single converter 10_{GM}, formed by three phase angle controlled thyristors, is associated with the 12 movable gripper coils 2_{GM} of the 3 sub-groups. The reduction of the number of converters associated with the movable gripper coils (one for 12 coils as opposed to one for 4 coils in FIG. 5) is made possible by the insertion of three switching thyristors 12 between the output of converter 10_{GM} and the three corresponding sub-groups of 4 movable gripper coils 2_{GM}. The switching thyristors 12 are not phase angle controlled but binary controlled, thereby constituting a multiplexing circuit a single output of which can, at any given moment, be connected to the input. As in FIG. 5, each sub-group of 4 stationary gripper coils 2_{GF} is associated with one converter 10_{GF} controlling the thyristors of said converter in phase angle. To enable troubleshooting when the reactor is in operation, switches 13a and 13b located on each side of the stationary gripper coils 2_{GF} are designed to connect the stationary gripper coils directly to an external power supply source (not represented).

In practice, maintenance and troubleshooting of current equipment are complex. In the event of a failure occurring, the neutron flux variation caused by dropping of a rod cluster automatically leads to an emergency shutdown of the whole reactor, within a very short time (1 s), which ages the reactor.

Moreover, this leads to more frequent stops the older the reactor is, leading to relatively high operating loss.

### OBJECT OF THE INVENTION

The object of the invention is to provide a control system of the rod control mechanisms of a nuclear reactor that does not present these shortcomings. More particularly, it has the object of providing a system making for easier maintenance and increasing the lifetime of a nuclear reactor.

According to the invention, this object is achieved by the fact that the system comprises a removable and independent power module for each coil, which module is connected in series with said coil and comprises a rectifier circuit itself connected between the three-phase current source and said coil and comprising three thyristors controlled in phase angle by a corresponding regulation circuit according to setpoint current values associated with said coil.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 represents a rod cluster control mechanism according to the prior art.

FIGS. 2a to 2c illustrate a known example of the current value I versus time t for a lift cycle, respectively for the stationary gripper coil (FIG. 2a), the movable gripper coil (FIG. 2b) and the lift coil (FIG. 2c).

FIGS. 3a to 3c illustrate a known example of the current value I versus time t for an insertion cycle, respectively in the stationary gripper coil (FIG. 3a), the movable gripper coil (FIG. 3b) and the lift coil (FIG. 3c).

FIG. 4 schematically illustrates a control system according to the prior art.

FIGS. 5 and 6 represent two embodiments of a rod control mechanism control system according to the prior art.

FIG. 7 represents a control system according to the invention.

FIG. 8 represents in greater detail a power module of the system according to FIG. 7.

FIGS. 9a to 9f represent various templates usable in a control system according to FIG. 7.

FIG. 10 illustrates a particular embodiment of a display interface of a control system according to FIG. 7.

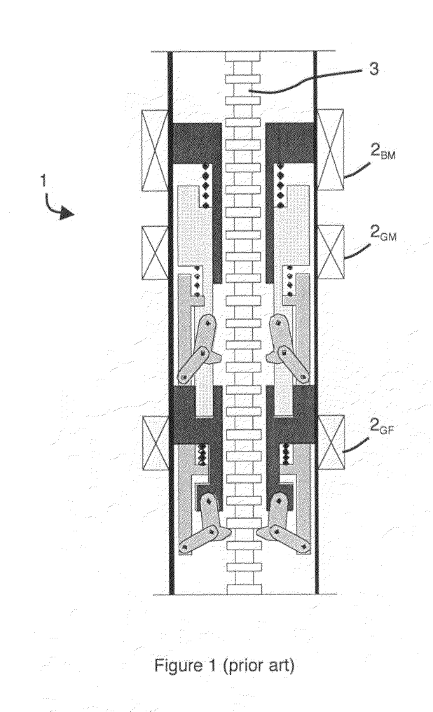

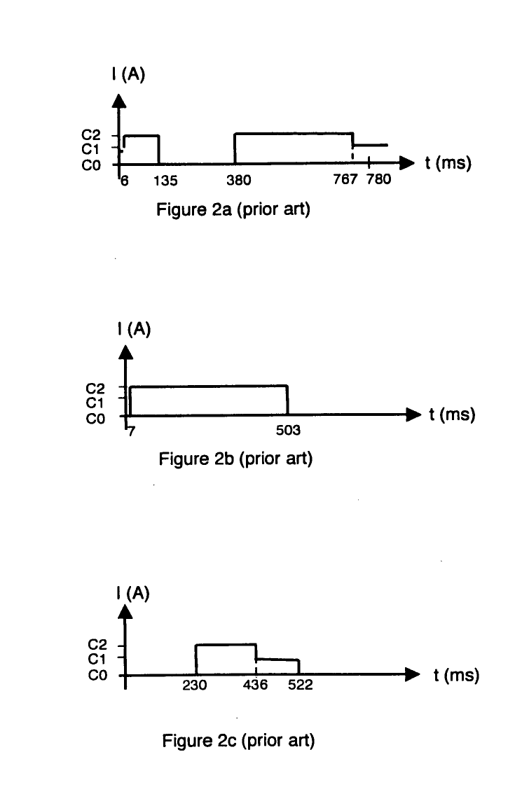

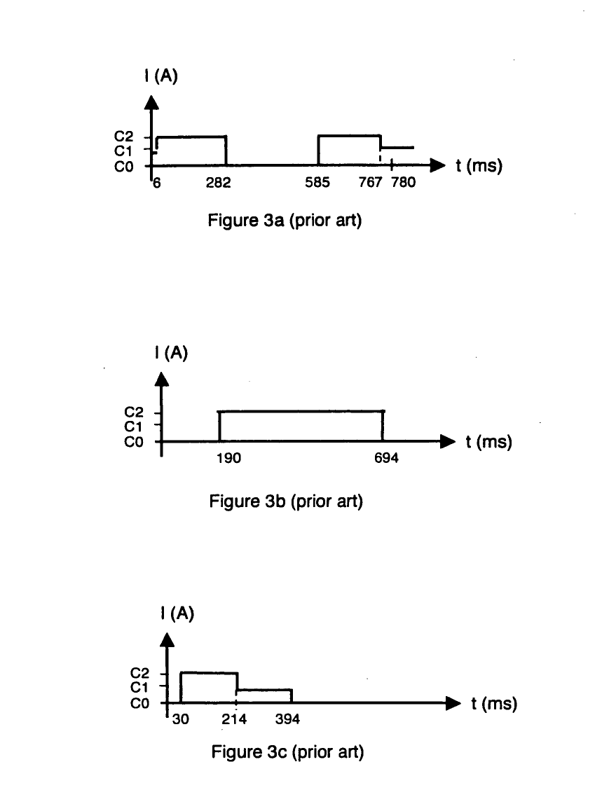

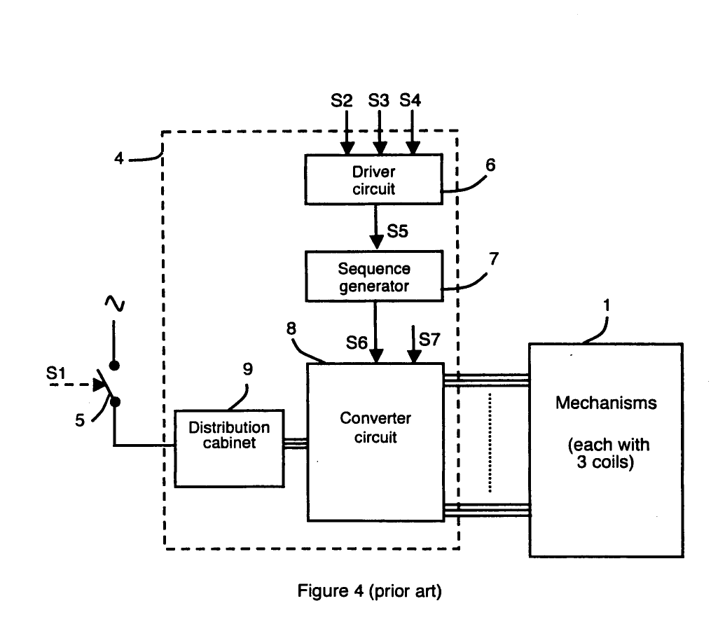

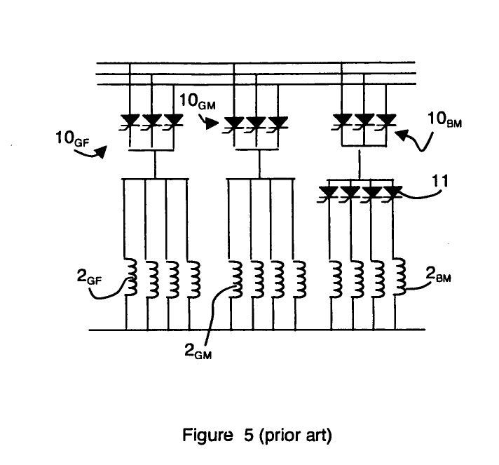

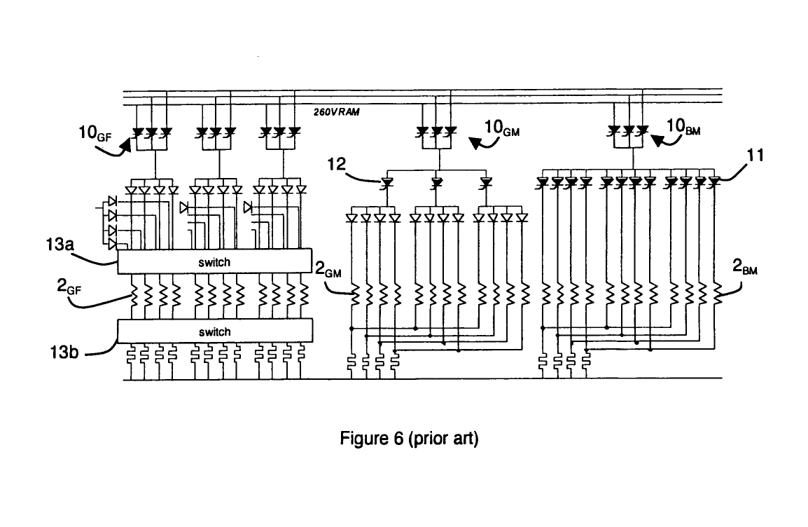

### DESCRIPTION OF A PREFERRED EMBODIMENT OF THE INVENTION

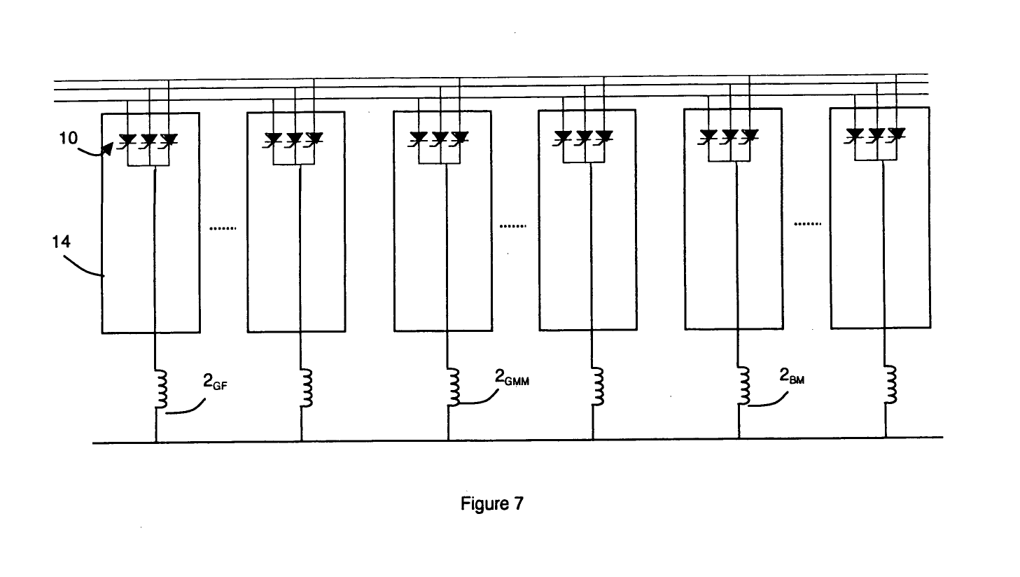

As represented in FIG. 7, the control system according to the invention comprises a removable power module 14 for each coil. Each power module 14 is connected in series with the corresponding coil 2 and comprises a converter 10, formed as before by a rectifier with three phase angle controlled thyristors. Thus in FIG. 7, a control cabinet designed for control of a sub-group of 4 control rod clusters comprises 12 distinct power modules 14 (only two are represented for each type of coil) respectively associated with the 12 coils of the sub-group (4 stationary gripper coils 2_{GF}, 4 movable gripper coils 2_{GM} and 4 lift coils 2_{BM}).

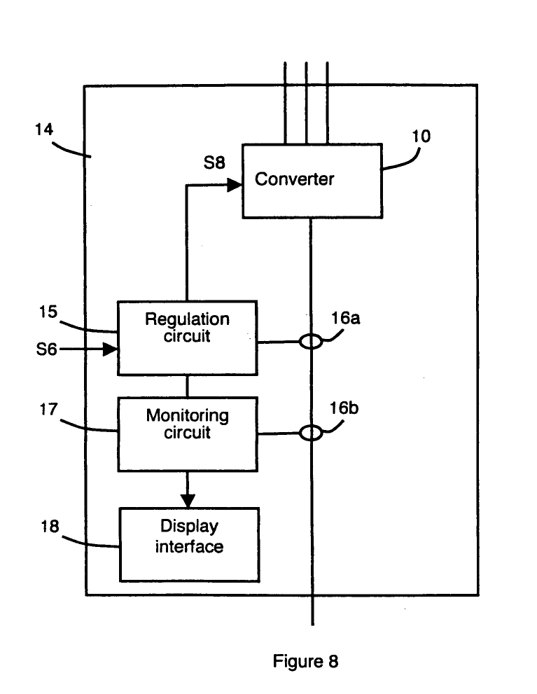

As illustrated in FIG. 8, each power module 14 includes a converter 10 and a corresponding regulation circuit 15. The latter is connected to a current sensor 16a and supplies converter 10 with signals S8 suitable for phase angle control of the converter thyristors according to setpoint current values associated with the coil and the current measured by sensor 16a. Power module 14 also comprises a monitoring circuit 17 connected to a current sensor 16b and to a display interface 18 to enable an operator to perform monitoring of the current flowing through the corresponding coil 2. The monitoring circuit comprises comparison means for comparing, with a predetermined time delay, the current measured by current sensor 16b with predetermined thresholds, which depend on corresponding setpoint values applied to the regulation circuit of the power module.

The regulation and monitoring circuits are connected to one another. They are preferably achieved with separate processing means to avoid common mode failures. Power modules 14 thus enable the current in each coil to be regulated and monitored individually and independently from one another.

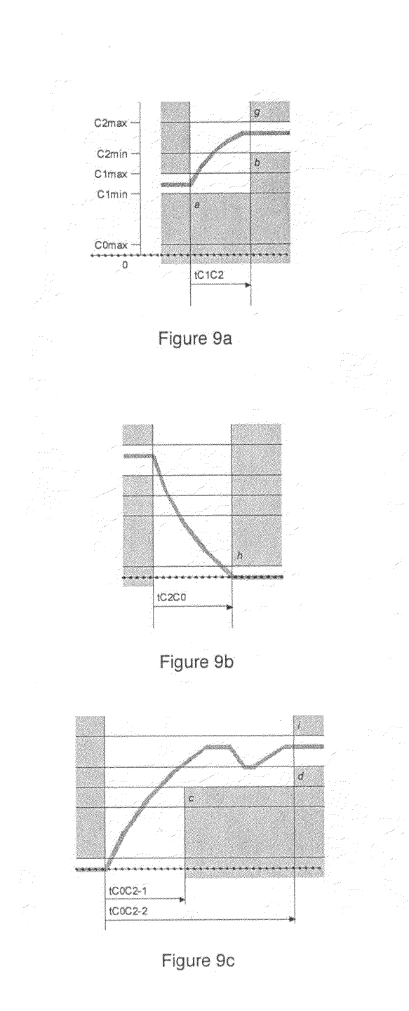

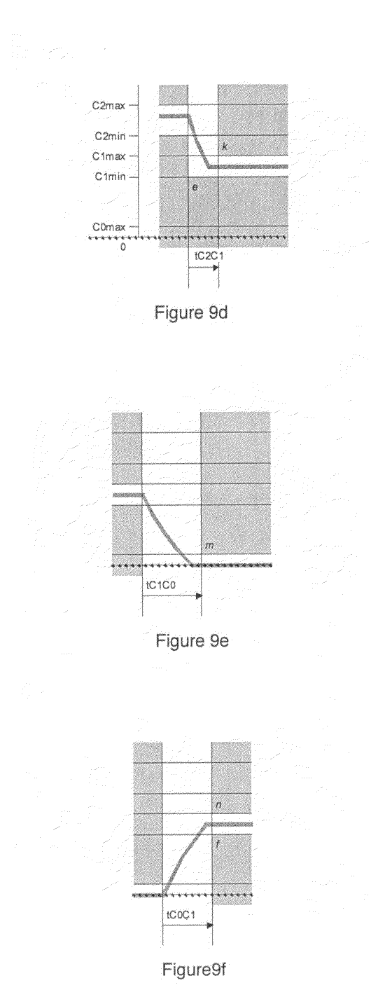

FIGS. 9a to 9f represent different templates or reference patterns used by monitoring circuits 17 of modules 14 to check that the current flowing through the corresponding coil remains within the tolerance range and within the imparted time with respect to signals S6 applied to regulation circuit 15 of module 14. These different reference patterns correspond respectively to 6 possible transitions between the 3 current levels, C0 (C0=0), C1 (hold current) and C2, able to flow in each coil. Thus for example, FIG. 9a illustrates a reference pattern used when a transition occurs from C1 to C2. The measured current, initially compared with thresholds C1max and C1min, is compared with thresholds C2min and C2max after a predetermined time delay tC1C2 associated with the transition from C1 to C2. Likewise, FIG. 9b illustrates a transition from C2 to C0 with an initial comparison with thresholds C2min and C2max and, after a time delay tC2C0, a comparison of the measured current with threshold C0max. For a transition from C0 to C2 (FIG. 9c), an initial comparison with C0max is followed by a comparison with threshold C1max, after a first time delay tCOC2-1, and by a comparison with thresholds C2min and C2max after a second time delay tC0C2-2. For a transition from C2 to C1 (FIG. 9d), an initial comparison with C2min and C2max is followed by a comparison with thresholds C1min and C1max after a time delay tC2C1. For a transition from C1 to C0 (FIG. 9e), an initial comparison with C1min and C1max is followed by comparison with threshold C0max after a time delay tC1C0. Finally, for a transition from C0 to C1 (FIG. 9f), an initial comparison with C0max is followed by comparison with thresholds C1min and C1max after a time delay tC0C1. The general monitoring principle is therefore identical for all the types of coils.

Power modules 14 are preferably standardized modules. They contain three sets of parameters (setpoints, threshold values and time delays), respectively associated with the stationary gripper coils 2_{GF}, movable gripper coils 2_{GM} and lift coils 2_{BM}.

Current sensors 16a and 16b are preferably magneto-resistive sensors which present the advantage in particular of being precise at low current. The same current sensors do in fact have to provide the necessary precision for all the types of coil. However, conventionally, for the stationary gripper coils 2_{GF} and movable gripper coils 2_{GM}, the maximum current value C2 is 8 A±0.3 A, the hold current value C1 is 4.7 A±0.2 A and the zero current C0 is comprised between 0 and 0.1 A, whereas for the lift coils 2_{BM}, C2=40 A±1.6 A and C1=16 A±1.6 A. This type of sensor provides an acceptable precision for all the levels involved.

Due to their standardization, power modules 14 are then overdimensioned for the stationary and movable gripper coils, which have the function of keeping the rods stationary.

In a preferred embodiment, each module 14 comprises means for automatic recognition of the type of the associated coil and for selecting the corresponding set of parameters (thresholds and time delays).

Each power module 14 is fitted in removable manner on a support frame (not represented), for example by means of complementary connectors (not represented). Automatic recognition of the type of coil can then be performed by means of type of coil coding elements (representative of the “type of frame”) provided on the connector associated with the support frame. Each power module can thus recognize its place in the control cabinet in which the locations corresponding to the different types of coil are predetermined.

In an alternative embodiment, automatic recognition of the type of coil is performed by detection of suitable encoding signals (representative of the “type of frame”) supplied to power module 14 by an external monitoring circuit when the power modules are fitted in the control cabinet. In a preferred embodiment, this information is supplied to the module by sequence generator 7. It is then not necessary to physically differentiate the different frames or to perform manual configuration of the module.

The control system described above, with a removable and independent power module 14 for each coil 2, presents the following advantages compared with known control systems:

The maximum current in each converter is reduced, in practice divided by 4. The converter thyristors can therefore be smaller and arranged on a printed circuit board accommodating the associated regulation and monitoring circuits. Integration of all the functions necessary for a coil in a single module then enables the production cost to be considerably reduced.

Each coil has an independent regulation. In this way, even in case of a thermal difference between coils, the proper current value is sent to each coil.

In the event of failure, the operator is directed to a single module-coil couple. Replacing the faulty plug-in module solves practically all cases of failure, even possible malfunctioning of the monitoring electronics. If the fault comes from the coil, the operator does not have to search for the faulty coil among four coils.

The number of types of spare parts is reduced for, in the event of a failure, a whole module is replaced by a standardized module, which enables stocks to be optimized and makes maintenance easier.

The alignment function does not require an additional thyristor in series with each coil. It is sufficient not to command the module corresponding to a particular lift coil to inhibit movement of the control rod cluster. This enables the heat losses of the power part to be reduced by 35%.

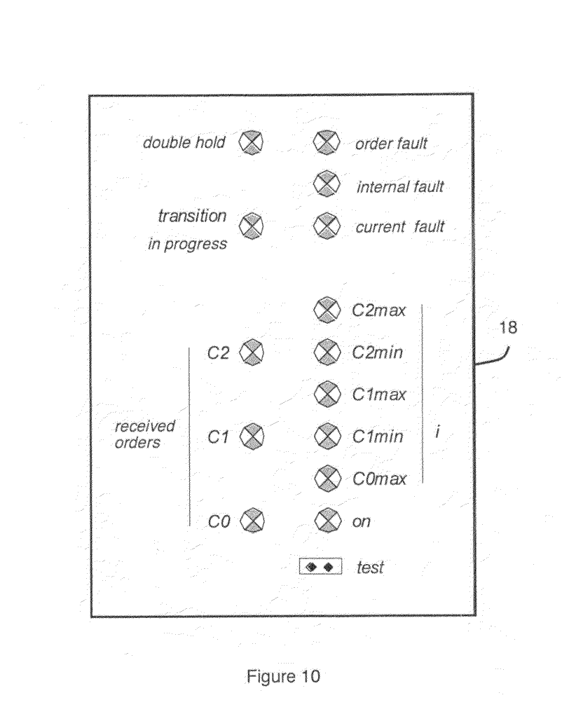

In a preferred embodiment illustrated in FIG. 10, the display interface 18 arranged on the front face of each power module 14 comprises a plurality of light-emitting diodes (LEDS) enabling the following to be simultaneously displayed:

The current level corresponding to the orders (signals S6) supplied to the module by sequence generator 7. Each display interface therefore comprises 3 setpoint light-emitting diodes (the 3 bottom LEDs of the left-hand column in FIG. 10) respectively associated with the three possible current levels (C0, C1 or C2, from bottom to top in FIG. 10).

The level of the current effectively flowing through the associated coil measured by current sensor 16b. In FIG. 10, this level is indicated by two monitoring light-emitting diodes associated with each setpoint current level which light up respectively when the corresponding minimum and maximum setpoint current values are reached. In FIG. 10, six monitoring LEDs are respectively associated with a zero current (“ON”, for the value C0min), with C0max, C1min, C1max, C2min and C2max (from bottom to top, the 6 LEDs of the right-hand column).

The setpoint LEDs and monitoring LEDs are preferably arranged in the form of two parallel columns, with an increasing current level, arranged in concordance. The monitoring LEDs thus form a bargraph, all the LEDs of which are lit up to the value measured in steady-state normal operating conditions, and it is easy for an operator to check whether the value of the measured current corresponds to the setpoint value or not.

A LED indicating a transition in progress (second LED of the left-hand column in FIG. 10) lights up during the time delay necessary for the current to go to its new setpoint value.

In the event of a fault in the current value produced, all of these LEDs are frozen until an acknowledgement is performed. The operator thereby knows which threshold tripped, and whether the fault occurred during a current transition or not.

Three fault indication light-emitting diodes (the top 3 LEDs of the right-hand column in FIG. 10) are provided to indicate the type of fault detected: fault in the orders (no order or several active orders), internal fault or current value fault.

A light-emitting diode indicates possible triggering of double hold, a fall-back state of the cabinet in which both types of gripper are activated to hold the control rod clusters pending maintenance.

1. A nuclear reactor rod control mechanism control system, each mechanism comprising three operating coils supplied from a three-phase current source, said system comprising a removable and independent power module for each coil, said module being connected in series with said coil and comprising a rectifier circuit itself connected between the three-phase current source and said coil and comprising three thyristors controlled in phase angle by a corresponding regulation circuit according to setpoint current values associated with said coil.

2. The system according to claim 1, wherein each power module comprises at least one current sensor to measure the current flowing in the corresponding coil.

3. The system according to claim 2, wherein one of the current sensors is connected to the corresponding regulation circuit.

4. The system according to claim 2, wherein one of the current sensors is connected to a monitoring circuit of the corresponding power module.

5. The system according to claim 3, wherein the current sensors are magnetoresistive sensors.

6. The system according to claim 4, wherein the monitoring circuit of a power module comprises comparison means for comparing, with a predetermined time delay, the current measured by the current sensor with predetermined thresholds which depend on corresponding setpoint values applied to the regulation circuit of the power module (14), said thresholds and said time delays constituting a set of parameters associated with the corresponding coil.

7. The system according to claim 6, wherein the power modules are standardized and each contain three sets of parameters respectively associated with each of the three coils of the corresponding mechanism, the power module comprising means for automatic recognition of the type of coil associated with said power module and for selecting the corresponding set of parameters according to the type of coil.

8. The system according to claim 7, wherein said means for automatic recognition comprise a power module connector designed to connect the power module to a complementary connector of a support frame, said complementary connector comprising the type of coil encoding elements.

9. The system according to claim 7, wherein said means for automatic recognition comprise means for detecting type of coil encoding signals, transmitted to the monitoring circuit from a control circuit external to the power module.

10. The system according to claim 2, wherein each power module comprises a display interface comprising a plurality of light-emitting diodes.

11. The system according to claim 10, wherein the display interface comprises setpoint light-emitting diodes respectively associated with different setpoint current levels.

12. The system according to claim 10, wherein the display interface comprises two monitoring light-emitting diodes associated with each setpoint current level and lighting up respectively when the minimum and maximum values of the corresponding setpoint current are reached by the current measured in the coil.

13. The system according to claim 12, wherein the monitoring light-emitting diodes are arranged in the form of a column with an increasing current level.

14. The system according to claim 11, wherein the display interface comprises a diode indicating a transition in progress.

15. The system according to claim 11, wherein the display interface comprises fault indication diodes.

16. The system according to claim 11, wherein the monitoring circuit of a module comprises means for freezing the light-emitting diodes of the display interface in the event of a fault, until receipt of an acknowledgement order.
